(19) United States
(12) Patent Application Publication
(10) Pub. No.: US 2012/0028000 A1
(43) Pub. Date: Feb. 2, 2012

(54) ANTI-NEWTON RING SHEET, AND TOUCH PANEL USING THE SAME

(75) Inventors: Takehiro Sasaki, Tokyo (JP); Taketo Ohnuki, Saitama (JP)

(73) Assignee: KIMOTO CO., LTD., Tokyo (JP)

(21) Appl. No.: 13/260,347

(22) PCT Filed: Feb. 25, 2010
(86) PCT No.: PCT/JP2010/052968

§ 371 Date: Sep. 25, 2011

(30) Foreign Application Priority Data
Mar. 27, 2009 (JP) 2009-077915

(51) Int. Cl. B32B 3/30

(52) U.S. Cl. 428/172; 428/156

(57) ABSTRACT

An anti-Newton ring sheet can be used for touch panels of various display screens such as those of high definition CRTs and FPDs used in recent years, and so forth. The anti-Newton ring sheet of the can include a plurality of structural rows 2 disposed side by side with a pitch, and heights of the structural rows can vary along extending directions of ridgelines thereof. The heights of the structural rows can vary periodically, and period of the variation can be in the range of 20 to 4000 μm.

This application is a U.S. national phase filing under 35 U.S.C. §371 of PCT Application No. PCT/JP2010/052968, filed Feb. 25, 2010, and claims priority under 35 U.S.C. §119 to Japanese patent application no. 2009-077915, filed Mar. 27, 2009, the entireties of both of which are incorporated herein by reference.

### TECHNICAL FIELD

The presently disclosed subject matter relates to an anti-Newton ring sheet, in particular, an anti-Newton ring sheet that is used for touch panels to be used on screens of various displays such as CRTs and FPDs and so forth, and a touch panel using the same.

### BACKGROUND ART

In the fields of photoengraving, liquid crystal device, optical equipment and so forth, a phenomenon called Newton ring occurs due to close contact of members such as plastic films and glass plates. Since this Newton ring can be prevented by maintaining the gap between closely contacting members to be not smaller than a certain level, there has so far been proposed an anti-Newton ring sheet in which unevenness is imparted to one or both surfaces of a member by forming an anti-Newton ring layer including a binder component and microparticles on the member.

However, as a result of spread of color CRTs, FPDs and so forth and use of higher color definition of various displays, there has arisen a problem that if such a conventional anti-Newton ring sheet is used for a touch panel, light from a light source is refracted in an undesired direction by fine convexes formed by the microparticles in the anti-Newton ring layer to cause a glaring phenomenon called sparkle, and thus a high definition color screen looks glaring.

Then, in recent years, in order to prevent such a glaring phenomenon, there have been proposed anti-Newton ring sheets imparted with not only the anti-Newton ring property, but also the anti-glaring property, by molding uneven profile of a desired size on the surfaces of the sheets (Patent documents 1 and 2).

### CONVENTIONAL ART REFERENCES

### Patent documents

Patent document 1: Japanese Patent Unexamined Publication No. 2004-362406 (Claims)
Patent document 2: Japanese Patent Unexamined Publication No. 2005-18726 (Claims)

### SUMMARY OF THE INVENTION

Such anti-Newton ring sheets as mentioned above indeed exhibit anti-Newton ring property and anti-glaring property. However, various displays have come to employ further higher definition in recent years, and in such various displays, it is becoming difficult to obtain both the anti-Newton ring property and the anti-glaring property with such techniques as described in the references mentioned above.

Therefore, an aspect of the presently disclosed subject matter is to provide an anti-Newton ring sheet that can exhibit the anti-Newton ring property and the anti-glaring property even in various displays of further higher definition, and a touch panel using it.

Concerning the aforementioned aspect, the inventors of the presently disclosed subject matter found that both the anti-Newton ring property and the anti-glaring property could be obtained in an anti-Newton ring sheet by molding a particular uneven profile not having been used so far on the surface of the sheet, and accomplished the presently disclosed subject matter.

That is, the anti-Newton ring sheet of the presently disclosed subject matter can have an uneven pattern on the surface, the uneven pattern can include a plurality of structural rows of which heights vary along extending directions of ridgelines thereof, and the structural rows are disposed side by side with a pitch in a direction crossing the extending directions of the ridgelines.

In accordance with the presently disclosed subject matter, each structural row may have a square, semicircular or triangular section, or a section in a shape that can include or can consist of a combination of two or more of these. The structural rows may have sections of different shapes, or may have sections of the same shape. Each structural row may have sections of a plurality of kinds of shapes. In an exemplary embodiment, the structural rows can include those having a section of a square shape. In another exemplary embodiment, all or most of the structural rows can have a section of a square shape. The “section of structural row” referred to here means a section along the direction perpendicular to the extending direction of the ridgeline of each structural row (refer to FIG. 2).

In an exemplary embodiment in accordance with the presently disclosed subject matter, each structural row can have a width of 2 to 30 μm at the base part thereof.

In accordance with the presently disclosed subject matter, the pitch, which is a distance between two adjacent structural rows, may vary depending on location, or may be fixed. An exemplary range for the pitch can be 20 to 4000 μm.

In accordance with the presently disclosed subject matter, when the section of the structural row has a square shape, widths of the peak part and the base part of the structural row may be the same or different. When they are different, the width of the peak part of the structural row may vary in the range of 3 to 99% of the width of the base part.

In accordance with the presently disclosed subject matter, when the structural row has a section of a semicircular shape, curvature radius of the peak part of the structural row may be 1 to 10 μm.

In accordance with the presently disclosed subject matter, the height of the structural row may vary randomly or periodically along the extending direction of the ridgeline. In an exemplary embodiment, the variation of the height of the structural row can have periodicity. In such a case, the period of height variation may be in the range of 20 to 4000 μm.

In an exemplary embodiment in accordance with the presently disclosed subject matter, the structural row can have an average height of 0.8 μm or larger. The “average height of structural row” referred to here is a distance from an average line of the ridgeline at the peak part of the structural row (refer to FIG. 1) to the base of the structural row (indicated with the symbol a in FIG. 1). When the uneven pattern is formed in the substrate itself (refer to FIGS. 3 and 4), the thickness of the part of the substrate where the uneven pattern is not formed (the part indicated with the numeral 5 in FIGS. 3 and 4) is not included in the height.

In accordance with the presently disclosed subject matter, the structural row can be formed with a polymer resin. In an exemplary embodiment, the structural row does not contain microparticles having a particle size of micrometer (μm) order, and can include only a polymer resin.

When the anti-Newton ring sheet of the presently disclosed subject matter is produced by injecting such a polymer resin (containing microparticles have a particle size of nanometer (nm) order, if necessary) into a mold, and transferring a pattern in the mold by shape transfer, the 2P method may be used as the method of the shape transfer, and a polymer resin containing 30 to 90% by weight of an ionizing radiation curable resin may be used as the polymer resin. Alternatively, the 2T method or the embossing method may be used as the method of the shape transfer, and a polymer resin containing 30 to 90% by weight of a thermosetting resin or a thermoplastic resin may be used as the polymer resin.

The anti-Newton ring sheet of the presently disclosed subject matter should have an uneven pattern on the surface, but the layer structure thereof is not particularly limited. For example, the anti-Newton ring sheet may have a single layer structure including a substrate that can include or can consist of a polymer resin (corresponding to the substrate 5 shown in FIG. 4, the same shall apply to the following descriptions), in which the uneven pattern is formed (refer to FIG. 3), or may have a laminated structure including a support and a layer laminated thereon and constituted by the uneven pattern (refer to FIG. 2). Furthermore, it may have a configuration that the anti-Newton ring sheet having a single layer structure mentioned above is laminated on a support (refer to FIG. 4).

Further, an exemplary embodiment of the anti-Newton ring sheet of the presently disclosed subject matter can have a hard coat layer on the side opposite to the surface on which the uneven pattern is formed.

Further, the touch panel of the presently disclosed subject matter can be a resistant film type touch panel including a pair of panel plates each having a conductive film and disposed via a spacer so that the conductive films face each other, wherein one or both of the conductive films are formed on the surface of the anti-Newton ring sheet of the presently disclosed subject matter on which the uneven pattern is formed.

In the anti-Newton ring sheet of the presently disclosed subject matter, a plurality of the structural rows of the uneven pattern formed on the surface are disposed side by side with a pitch, and the heights of the structural rows vary along extending directions of ridgelines thereof. Therefore, it shows superior anti-Newton ring property, and can be used as an anti-Newton ring sheet hardly giving sparkles or conspicuous glaring on color screen, even when it is used in a touch panel using a color display of higher definition.

Further, since the touch panel of the presently disclosed subject matter utilizes the anti-Newton ring sheet mentioned above, it does not give sparkles and glaring color screens, and also provides good visibility for the front direction.

### BRIEF DESCRIPTION OF THE DRAWINGS

FIG. 1 is a perspective view of an anti-Newton ring sheet according to one embodiment of the presently disclosed subject matter.

FIG. 2 is a sectional view of the sheet shown in FIG. 1 along a line perpendicular to the extending directions of the ridgelines of the structural rows.

FIG. 3 is a sectional view of an anti-Newton ring sheet according to another embodiment of the presently disclosed subject matter.

FIG. 4 is a sectional view of an anti-Newton ring sheet according to still another embodiment of the presently disclosed subject matter.

FIG. 5 is a sectional view of a touch panel using the sheet shown in FIG. 1.

FIG. 6 is a sectional view of an uneven pattern for preventing Newton-ring according to another embodiment, which can be used for the touch panel shown in FIG. 5.

### DESCRIPTION OF NUMERICAL NOTATIONS

1, 1b, 1c . . . . Anti-Newton ring sheet, 1a . . . uneven pattern, 2 . . . structural row, 3 . . . pitch, 4 . . . support, 5 . . . substrate, 50 . . . touch panel, 52 . . . upper electrode substrate, 522 . . . upper transparent substrate (panel plate), 524 . . . upper transparent conductive film (conductive film), 54 . . . lower electrode substrate, 542 . . . lower transparent substrate (panel plate), 544 . . . lower transparent conductive film (conductive film), 56, 58 . . . spacer, 7 . . . adhesive layer, 9 . . . display device.

### DETAILED DESCRIPTION OF EXEMPLARY EMBODIMENTS

The anti-Newton ring sheet of the presently disclosed subject matter can have an uneven pattern on the surface, and the uneven pattern can include or can consist of a plurality of structural rows of which heights vary along the extending directions of the ridgelines thereof. Further, a plurality of the structural rows are disposed side by side with a pitch in a direction crossing the extending directions of the ridgelines. Further, the touch panel of the presently disclosed subject matter is a touch panel utilizing the anti-Newton ring sheet of the presently disclosed subject matter. Hereafter, embodiments of the anti-Newton ring sheet of the presently disclosed subject matter will be explained.

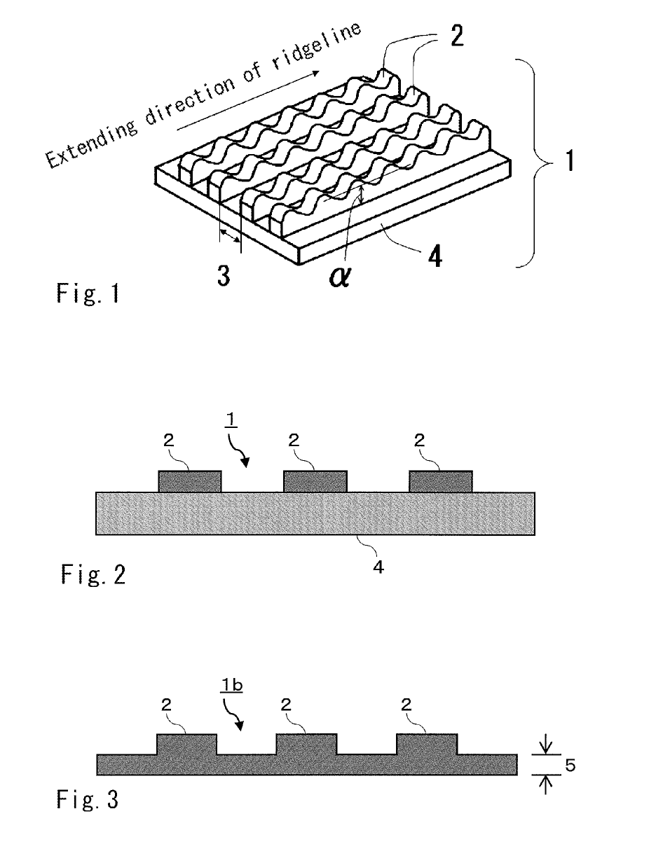

As shown in FIGS. 1 and 2, an anti-Newton ring sheet 1 according to one embodiment of the presently disclosed subject matter has an uneven pattern on a surface of a support 4. The uneven pattern can include or can consist of a plurality of structural rows 2. A plurality of the structural rows 2 are configured so that heights thereof vary along the extending directions of the ridgelines, and are disposed side by side with a pitch 3 along the direction perpendicular to the extending directions of the ridgelines.

Since the anti-Newton ring sheet 1 of this embodiment is configured by disposing a plurality of the structural rows 2 side by side with a pitch 3 on the surface of the support 4, it can prevent such glaring as generated by fine convexes formed with microparticles in the conventional anti-Newton ring sheets. Further, since the heights of the structural rows 2 vary along the extending directions of the ridgelines thereof (peak parts of the structural rows 2), the surface of the anti-Newton ring sheet 1 having the structural rows 2 (surface having the uneven pattern) contacts with a facing member at scattered points, and therefore the anti-Newton ring sheet 1 can also effectively prevent Newton rings.

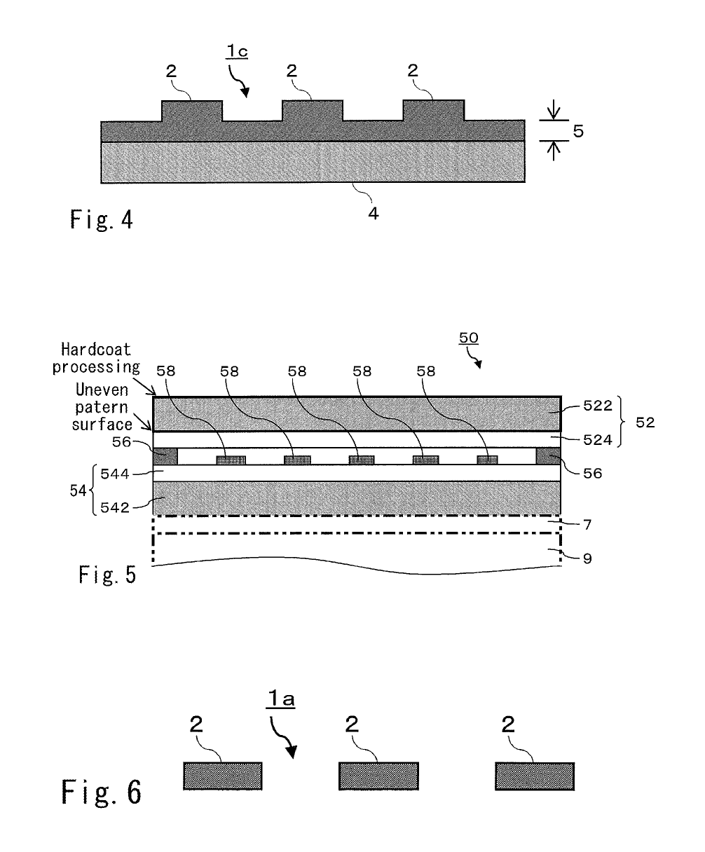

Although FIGS. 1 and 2 show examples of the layer structure in which a predetermined uneven pattern is laminated on the surface of the support 4, structure of the anti-Newton ring sheet of the presently disclosed subject matter is not limited to this structure. For example, as shown in FIG. 3, the anti-Newton ring sheet of the presently disclosed subject matter may be an anti-Newton ring sheet 1b having a single layer structure that can include or can consist of a substrate 5 in which an uneven pattern constituted by the structural rows 2 is formed. Alternatively, as shown in FIG. 4, the anti-Newton ring sheet of the presently disclosed subject matter may be an anti-Newton ring sheet 1c including the single layer structure shown in FIG. 3 laminated on the surface of the support 4.

The structural rows 2 used in this embodiment mainly constituted by a polymer resin. In the conventional anti-Newton ring sheets, in order to form an uneven profile, microparticles having a particle size of micrometer (μm) order or the like are used in addition to a polymer resin. However, the structural rows 2 used in this embodiment is constituted by a convex pattern formed by a shape transfer technique, of which typical examples are the 2P method, the 2T method, the embossing method, etc., it can include only a polymer resin without using such microparticles as mentioned above.

Therefore, when the anti-Newton ring sheet having the structural rows 2 is used as a member of a touch panel, it can prevent the glaring called sparkle. Further, since the uneven profile is formed by a shape transfer technique, not by microparticles, increase of the internal and external haze values is suppressed, and more favorable transparency is obtained compared with the conventional anti-Newton ring sheets. When the structural rows 2 are formed in the substrate 5 (refer to FIGS. 3 and 4), as described above, the substrate 5 is also constituted by such a polymer resin.

Examples of the polymer resin include ionizing radiation curable resins, thermosetting resins, thermoplastic resins, moisture curable resins, and so forth. When the structural rows are formed by the 2P method, an ionizing radiation curable resin is used, and when the structural rows are formed by the 2T method or the embossing method, a thermosetting resin or a thermoplastic resin is used. Although moisture curable resins can be used for both the 2P method and the 2T method, it is suitable for formation of the structural rows by the 2T method.

As the ionizing radiation curable resins, photopolymerizable prepolymers that can cure through crosslinking caused by irradiation of ionizing radiation (ultraviolet radiation or electron beam) can be used. Exemplary photopolymerizable prepolymers can include but are not limited to, acrylic type prepolymers that have two or more acryloyl groups in the molecule and cure through crosslinking to form a three-dimensional reticular structure. As such acrylic type prepolymers, urethane acrylates, polyester acrylates, epoxy acrylates, melamine acrylates, polyfluoroalkyl acrylates, silicone acrylates, and so forth can be used. Although these acrylic type prepolymers can be used independently, in an exemplary embodiment, photopolymerizable monomers can be added in order to improve the crosslinking curable property and further improve hardness of the structural rows 2.

As the photopolymerizable monomers, there are used one or two or more kinds of monomers among monofunctional acrylic monomers such as 2-ethylhexyl acrylate, 2-hydroxyethyl acrylate, 2-hydroxypropyl acrylate and butoxyethyl acrylate, bifunctional acrylic monomers such as 1,6-hexanediol diacrylate, neopentylglycol diacrylate, diethylene glycol diacrylate, polyethylene glycol diacrylate and hydroxypivalic acid ester neopentylglycol diacrylate, polyfunctional acrylic monomers such as dipentaerythritol hexaacrylate, trimethylpropane triacrylate and pentaerythritol triacrylate, and so forth.

When the structural rows are formed by curing the photopolymerizable prepolymers and photopolymerizable monomers mentioned above with ultraviolet irradiation, an exemplary embodiment can use additives such as, but not limited to, photopolymerization initiators and photopolymerization enhancers.

Examples of the photopolymerization initiators can include acetophenone, benzophenone, Michler's ketone, benzoin, benzyl methyl ketal, benzoyl benzoate, α-acyl oxime ester, thioxanthones, and so forth.

The photopolymerization enhancers can accelerate the curing rate by reducing polymerization disturbance caused by air at the time of curing, and examples include p-dimethylaminobenzoic acid isoamyl ester, p-dimethylaminobenzoic acid ethyl ester, and so forth.

Further, an exemplary ionizing radiation curable resin can include an ionizing radiation curable organic-inorganic hybrid resin. The ionizing radiation curable organic-inorganic hybrid resin referred to in the presently disclosed subject matter means a material showing a closely mixed state of organic substances and inorganic substances, and a dispersion state of a molecular level or a dispersion state close to that, unlike the composite materials having been used from old days, of which typical example is fiber-glass reinforced plastics (FRP), and it can form coated film by a reaction of an inorganic component and an organic component induced by irradiation of ionizing radiation. Examples of the inorganic component of such ionizing radiation curable organic-inorganic hybrid resins include metal oxides such as silica and titania. In an exemplary embodiment, an ionizing radiation curable organic-inorganic hybrid resin using silica can be used.

Examples of the thermosetting resins include silicone resins, phenol resins, urea resins, melamine resins, furan resins, unsaturated polyester resins, epoxy resins, diallyl phthalate resins, guanamine resins, ketone resins, aminoalkyd resins, urethane resins, acrylic resins, polycarbonate resins, and so forth. Although they can be independently used, in an exemplary embodiment, a curing agent can be added in order to further improve crosslinking property and hardness of coated film cured by crosslinking.

As the curing agent, such compounds as polyisocyanates, amino resins, epoxy resins, and carboxylic acids can be appropriately used according to the resin used.

Examples of the thermoplastic resins include ABS resins, norbornene resins, silicone resins, nylon resins, polyacetal resins, polycarbonate resins, modified polyphenylene ether resins, polybutylene terephthalates, polyethylene terephthalates, sulfone resins, imide resins, fluorocarbon resins, styrene resins, acrylic resins, vinyl chloride resins, vinyl acetate resins, vinyl chloride/vinyl acetate copolymer resins, polyester resins, urethane resins, nylon resins, rubber type resins, polyvinyl ethers, polyvinyl alcohols, polyvinylbutyrals, polyvinylpyrrolidones, polyethylene glycols, and so forth.

Among these thermosetting resins and thermoplastic resins, an exemplary embodiment can use an acrylic thermosetting resin or thermoplastic resin in view of the coated film strength and favorable transparency at the time of use as the structural rows. Moreover, these thermosetting resins and thermoplastic resins can also be used as a composite resin including suitably combined two or more kinds of thermosetting resins or two or more kinds of thermoplastic resins.

The moisture curable resin is a resin of which curing advances through a reaction with moisture in the air, and examples include, for example, single pack silicone resins, single pack modified silicone resins, single pack polyurethane resins, two pack modified silicone resin, and so forth. Such moisture curable resins has an advantage that the structural rows 2 can be formed with them without using external energy such as light and heat, which may be required when an ionizing radiation curable resin, a thermosetting resin, or a thermoplastic resin is used.

A resin other than the resins mentioned above can also be used together in the polymer resin constituting the structural rows 2, and an exemplary resin content in a polymer resin constituted by two or more kinds of resins, can be 30% by weight or more of an ionizing radiation curable resin is contained based on the total polymer resin components in order to form a convex pattern with good precision by a shape transfer technique, when the 2P method is used. In an exemplary embodiment when the 2T method or the embossing method is used, 30% by weight or more of a thermosetting resin or a thermoplastic resin can be used based on the total polymer resin components.

In addition, the structural rows 2 may contain various additives such as lubricants, optical whitening agents, microparticles, antistatic agents, flame retardants, antibacterial agents, antifungal agents, ultraviolet absorbers, light stabilizers, antioxidants, plasticizers, leveling agents, flow regulators, antifoams, dispersing agents, surface lubricant, and crosslinking agents, besides the polymer resin, in such an extent that the effect of the polymer resin should not be degraded. The microparticles referred to here are not such microparticles having a particle size of micrometer order as used in the conventional anti-Newton ring sheets, but those having a particle size of nanometer order.

The structural row 2 used in this exemplary embodiment can be a square, semicircular or triangular sectional shape for a section along the direction perpendicular to the extending direction of the ridgeline. The “structural row 2 having a square sectional shape” includes structural rows having any square section such as rectangular section and trapezoid section, and the “structural row 2 having a semicircular sectional shape” includes structural rows having any section such as a semicircular section, a semielliptic section, and an elliptic section. Further, the “structural row 2 having a triangular sectional shape” includes not only one having a triangular section, but also one having a corner-rounded triangular section. The anti-Newton ring sheet of this embodiment may have the structural rows 2 having a plurality of kinds of sectional shapes, or the structural rows 2 having a single kind of sectional shape. However, when the structural rows 2 are constituted only by those having a square sectional shape, refraction of lights due to the surface profile can be suppressed to be little, and more favorable transparency can be obtained.

When the structural row 2 has a section of a square shape, width of the peak part and the width of the base part of the section of the structural row 2 may be the same or different. When the widths of the structural row 2 are different, in an exemplary embodiment, the width of the peak part can be in the range of 3 to 99% of the width of the base part. Further, in the case of the structural row 2 having a semicircular sectional shape, an exemplary curvature radius can be 1 to 10 μm at the peak part.

The height of the structural row 2 varies along the extending direction of the ridgeline thereof. Although the height of the structural row 2 may vary randomly or periodically along the extending direction of the ridgeline thereof, in an exemplary embodiment, the height of the structural row 2 periodically varies, in order to obtain the anti-Newton ring property and favorably prevent glaring at the same time. In this exemplary case, the period of the variation of the height of the structural row 2 can be 20 to 4000 μm. When the period of the variation of the height of the structural row 2 is 20 μm or larger, glaring can be favorably prevented even in various displays of higher definition. Further, when the period of the variation is 4000 μm or smaller, the anti-Newton ring property can be obtained.

In one exemplary embodiment, the period of the variation can be in the range of 120 to 800 μm, and in another exemplary embodiment, the range can be 150 to 500 μm. However, in order to obtain the anti-Newton ring property and favorably prevent moiré at the same time, which may be generated depending on combination with a liquid crystal panel or the like having a regular structure, in an exemplary embodiment, the height of the structural row 2 varies randomly. The “period of the variation of the height” of the structural row 2 means the distance from a peak of one convex part on the ridgeline at the top of the structural row 2 to a peak of the next convex part on the ridgeline at the top of the structural row 2.

In one embodiment, average height of the structural row 2 can be 0.8 μm or larger, in another embodiment, the height can be 0.8 to 10 μm, and in yet another embodiment, the height can be 2 to 6 μm. When the average height is 0.8 μm or larger, favorable anti-Newton ring property can be obtained. When the average height is 10 μm or smaller, superior durability and handling property of the anti-Newton ring sheet can be obtained. The average height of the structural row 2 means the distance from the average line of the ridgeline at the top of the structural row 2 (refer to FIG. 1) to base of the structural row 2 (distance indicated with the character α in FIG. 1) as described above, and when the uneven pattern is formed in the substrate itself (refer to FIGS. 3 and 4), the thickness of the part of the substrate where the uneven pattern is not formed (the part indicated with the numeral 5 in FIGS. 3 and 4) is not included in the height.

Further, magnitude of the variation of the height of the structural row 2 can 0.8 μm or more in one embodiment, and in the range of 0.8 to 10 μm in another embodiment. When magnitude of the variation of the height is 0.8 μm or larger, favorable anti-Newton ring property can be obtained. The magnitude of “variation of the height” of the structural row 2 means the distance between the highest top of convex on the ridgeline (maximum height) and the lowest bottom of concave (minimum height) of the structural row 2.

The width of the base part of the structural row 2 can be 2 to 30 μm in one embodiment, and more 3 to 10 μm in another embodiment. When the width of the structural row 2 is 2 μm or larger, superior durability of the anti-Newton ring sheet can be obtained. Further, when the width of the structural row 2 is 20 μm or smaller, glaring can be prevented even in various displays of higher definition.

The pitch 3 of the structural rows 2 (interval between two adjacent structural rows 2 in FIG. 1) can be 20 to 4000 μm in one exemplary embodiment, 40 to 800 μm in another exemplary embodiment, and 90 to 500 μm in yet another exemplary embodiment. When the pitch 3 of the structural rows 2 is 20 μm or larger, haze can be suppressed to be low. Further, when the pitch 3 of the structural rows 2 is 4000 μm or smaller, superior durability of the anti-Newton ring sheet 1 can be obtained. In addition, the pitch 3 between the structural rows 2 may change along the extending directions of the ridgelines of the structural rows 2.

The structural rows 2 described above can be formed by using a mold having a profile complementary to the structural rows 2. Although the method for producing the mold having a profile complementary to the structural rows 2 used in this embodiment is not particularly limited, for example, concaves are formed on a plate by a microdrilling technique using a cutting tool having a specific sectional shape at the tip with controlling the cutting depth, and this plate is used as a mold for molding (female mold). Alternatively, convexes having a specific shape are formed on a plate by a laser microprocessing technique, and this plate is used as a male mold to produce a mold for molding (female mold).

As shown in FIGS. 1, 2 and 4, when the support 4 is used, highly transparent supports such as those including or consisting of a glass plate, a plastic film or the like can be used as the support. Exemplary embodiments of the glass plate can include plate glass produced from oxidized glass such as silicate glass, phosphate glass and borate glass can be used, and other exemplary embodiments can include plate glass produced from silicic acid glass, or silicate glass such as alkali silicate glass, soda lime glass, potash lime glass, lead glass, barium glass and borosilicate glass. As the plastic film, for example, those that can include or can consist of polyethylene terephthalate, polybutylene terephthalate, polyethylene naphthalate, polycarbonate, polyethylene, polypropylene, polystyrene, triacetylcellulose, acrylic resin, polyvinyl chloride, norbornene resin and so forth can be used, and stretched, especially biaxially-stretched, polyethylene terephthalate films can be used, because of superior mechanical strength and dimensional stability thereof. An exemplary embodiment of the support can be those of which surfaces are subjected to an adhesion-promoting treatment such as a plasma treatment, corona discharge treatment, far ultraviolet ray irradiation, or formation of adhesion-promoting undercoat layer.

Thickness of the support 4 is not particularly limited, and can be appropriately chosen for the material used, and can be generally about 25 to 500 μm in an exemplary embodiment, and about 50 to 300 μm in another exemplary embodiment, if handling property and so forth of the anti-Newton ring sheet are taken into consideration.

The anti-Newton ring sheet 1 having the structural rows 2 can be formed by a shape transfer technique, such as the 2P method, the 2T method and the embossing method. For example, the aforementioned anti-Newton ring sheet 1 having the structural rows 2 forming a convex pattern can be obtained by filling such a polymer resin for forming the structural rows 2 as mentioned above or the like into a mold having a concave pattern complementary to the desired convex pattern to carry out shape transfer, then curing the polymer resin or the like, and releasing it from the mold. When the support 4 is used, the anti-Newton ring sheet 1 having the structural rows 2 provided on the support 4 can be obtained by filling a polymer resin or the like into the mold, superimposing the support thereon, then curing the polymer resin or the like, and releasing them from the mold.

Among the shape transfer techniques mentioned above, it can be advantageous to use the 2P method because it enables production of the anti-Newton ring sheet in a relatively short period of time, and it does not require heating and cooling, i.e., it can suppress deformation of the constituent members by heat. However, from the viewpoints of high degree of freedom for selection of materials of constituent members and reduction of process cost, it can be advantageous to use the 2T method.

Further, if the embossing method is used for the formation of the structural rows, which is performed at ordinary temperature, a profile having more rounded angles is obtained compared with the profile of the plate (embossing roll) due to the elasticity of the polymer resin at the time of the formation, and it can become difficult to obtain an uneven profile of a desired size. For this reason, in order to form the desired uneven profile, it can be more advantageous to employ the 2P method or the 2T method.

As for the method for curing the polymer resin, when the polymer resin is an ionizing radiation curable resin, it can be cured by irradiation of an ionizing radiation. When the polymer resin is a thermosetting resin, it can be cured by application of heat. As the ionizing radiation, for example, a ultraviolet ray in a an exemplary wavelength region of 100 to 400 nm, or in another exemplary region of 200 to 400 nm, emitted from, for example, an ultra high pressure mercury lamp, high pressure mercury lamp, low pressure mercury lamp, carbon arc, metal halide lamp, or the like, or an electron beam in a wavelength region of 100 nm or smaller emitted from a scanning type or curtain type electron beam accelerator can be used.

Heating temperature of the thermosetting resin is determined in consideration of type of the resin, thickness of the anti-Newton ring layer etc., and it is advantageously in the range of 80 to 200° C.

Coated film strength of the structural row 2 after curing of the polymer resin can be such that the surface of the structural row 2 does not show tackiness. Further, in an exemplary embodiment, the structural row 2 can have a pencil hardness of HB or higher according to JIS K5400:1990. If the structural rows 2 have such a coated film strength as mentioned above, when the anti-Newton ring sheet 1 having the structural rows 2 is used in a touch panel, the structural rows 2 are not easily deformed, and show superior durability.

Further, according this embodiment, a hard coat layer may be provided on a surface of the anti-Newton ring sheet 1 on the side opposite to the side on which the uneven pattern that can include or can consist of the structural rows 2 is formed.

By using a configuration that an anti-Newton ring layer is provided on one side, and a hard coat layer is provided on the other side, not only the anti-scratching effect is attained by the hard coat layer, but also “curving” of the anti-Newton ring sheet 1 can be prevented, and good quality of a product including the anti-Newton ring sheet 1, for example, touch panel, can be maintained.

The hard coat layer is formed with such a resin as an ionizing radiation curable resin, a thermosetting resin, a thermoplastic resin, or a moisture curable resin. Among these, an exemplary embodiment can use the ionizing radiation curable resin because hard coat property can be easily obtained with it. These resins may be similar to the aforementioned ionizing radiation curable resins, thermosetting resins, thermoplastic resins, and moisture curable resins usable as the structural row 2.

The hard coat layer is desirably prepared so that scratches are not formed when steel wool #0000 is reciprocally moved 10 times on it with a load of 300 g in one exemplary embodiment, and 500 g in another exemplary embodiment. If the hard coat layer is prepared as described above, the desired hard coat property can be secured.

Further, the hard coat layer is desirably prepared to have a pencil scratch value (pencil hardness) of H or higher in one exemplary embodiment, 2H or higher in another exemplary embodiment, and 3H or higher in yet another exemplary embodiment. If the pencil scratch value is adjusted to be higher than the predetermined value, generation of scratches on the surface of the hard coat layer can be effectively prevented. Value of the pencil scratch value is a value determined by the method of JIS K5400:1990.

Anti-scratch property and hardness of the hard coat layer can be adjusted by choosing type of the resin constituting the hard coat layer, conditions of curing, and so forth.

Thickness of the hard coat layer can be 0.1 to 30 μm in one exemplary embodiment, 0.5 to 15 μm in another exemplary embodiment, and 2 to 10 μm in yet another exemplary embodiment. With a thickness of the hard coat layer of 0.1 μm or larger, sufficient hard coat property can be imparted. Further, with a thickness of 30 μm or smaller, generation of curl and undercure of the layer can be more easily prevented.

The above hard coat layer can be formed by mixing a resin such as the aforementioned ionizing radiation curable resin, additives, dilution solvent, and so forth used as may be required to prepare a coating solution for hard coat layer, applying the solution on a surface of the anti-Newton ring sheet 1 on the side opposite to the side on which the structural rows 2 are formed by a conventionally known coating method such as those using bar coater, die coater, blade coater, spin coater, roll coater, gravure coater, curtain flow coater, spray and screen printing, drying the coated layer as may be required, and curing the ionizing radiation curable resin by irradiation of an ionizing radiation.

For example, when the anti-Newton ring layer and the hard coat layer are formed on a support, either the anti-Newton ring layer or the hard coat layer may be formed first. Further, when both the hard coat layer and the anti-Newton ring layer include ionizing radiation curable resins, it is possible to form one layer while the other layer is half-cured, and then cure the both layers at the same time.

Besides the anti-Newton ring sheet 1 of the presently disclosed subject matter explained above, as another embodiment, an anti-Newton ring uneven pattern la shown in FIG. 6 including neither the substrate 5 nor the support 4, and include only the uneven pattern of the presently disclosed subject matter can also be used. This anti-Newton ring uneven pattern 1a can be produced by, for example, delaminating the support of the anti-Newton ring sheet 1 shown in FIG. 2.

Hereafter, embodiments of the touch panel of the presently disclosed subject matter will be explained.

As shown in FIG. 5, a touch panel 50 according to one embodiment of the presently disclosed subject matter is a touch panel of the resistance film type mounted on a front surface of a display device 9 such as liquid crystal display devices provided in various electronic equipment (for example, cellular phones, car navigation systems, etc.). Characters, symbols, patterns, etc. displayed on the display device 9 on the back surface side can be recognized and selected through the touch panel 50, and pushed with a finger, a pen for exclusive use or the like to switch functions of the equipment.

The touch panel 50 of this embodiment has an upper electrode substrate 52 and a lower electrode substrate 54. The upper electrode substrate 52 has an upper transparent substrate 522 (panel plate), and an upper transparent conductive film (conductive film) 524 is formed on the lower surface of the upper transparent substrate 522. The lower electrode substrate 54 has a lower transparent substrate 542 (panel plate), and a lower transparent conductive film (conductive film) 544 is formed on the upper surface of the lower transparent substrate 542.

Although either the upper electrode substrate 52 or the lower electrode substrate 54 of the touch panel 50 may be a movable electrode, a touch panel in which the upper electrode substrate 52 is a movable electrode, and the lower electrode substrate 54 is a fixed (unmovable) electrode is exemplified for this embodiment.

Examples of the upper and lower transparent conductive films 524 and 544 include inorganic thin films showing transparency and electrical conductivity including metals such as In, Sn, Au, Al, Cu, Pt, Pd, Ag and Rh, or metal oxides such as indium oxide, tin oxide, and composite oxide thereof, ITO, and organic thin films including aromatic conductive polymers such as polyparaphenylene, polyacethylene, polyaniline, polythiophene, polyparaphenylene vinylene, polypyrrole, polyfuran, polyselenophene and polypyridine.

As the upper transparent substrate 522 and/or the lower transparent substrate 542, the materials mentioned for the support 4 in the detailed explanation of the anti-Newton ring sheet 1 mentioned above or the anti-Newton ring sheet 1 mentioned above can be used. When such materials are used, the aforementioned transparent conductive films 524 and 544 as inorganic thin films can be formed by vacuum film formation techniques such as vacuum deposition, sputtering, and ion-plating, or those as organic thin films can be formed by conventionally known coating methods, on one surface of the support 4 or the anti-Newton ring sheet 1. In an exemplary embodiment, the surface of the upper transparent substrate 522 and/or the lower transparent substrate 542 as such panel plates to be touched is subjected to an arbitrary hard coat treatment.

In this embodiment, peripheral portions of the lower surface of the upper electrode substrate 52 and the upper surface of the lower electrode substrate 54 are adhered via a spacer 56 of a frame-like shape. Further, the upper transparent conductive film 524 of the upper electrode substrate 52 and the lower transparent conductive film 544 of the lower electrode substrate 54 are disposed so that they should face each other with a predetermined gap. A plurality of dot-like spacers 58 are disposed with predetermined intervals on the upper surface of the lower transparent conductive film 544 as may be required. The spacers 58 may be disposed as desired, and a configuration not using the spacer 58 is also possible.

The dot-like spacers 58 are formed in order to secure a void between panel plates of a pair of panel plates, to control load of touching, to provide favorable detachment of panel plates after touching, or the like. For such spacers 58, a transparent ionizing radiation curable resin is generally used, and they can be obtained by forming them as fine dots by a photo process. Further, they can also be formed by printing many fine dots by a printing method such as silk screen printing using a urethane type resin or the like. Furthermore, they can also be obtained by spraying or applying a dispersion of particles that can include or can consist of an inorganic substance or an organic substance and drying it. Although size of the spacers 58 changes depending on size of the touch panel, and therefore it cannot be definitely defined, they are generally formed as dots having a diameter of 30 to 100 μm and a height of 1 to 15 μm, and disposed at certain intervals of 0.1 to 10 mm.

At the both ends of the upper and lower transparent conductive films 524 and 544, a pair of electrodes (not shown in the drawing) are formed, respectively. In this embodiment, a pair of upper electrodes (not shown in the drawing) formed on the upper transparent conductive film 524 and a pair of lower electrodes (not shown in the drawing) formed on the lower transparent conductive film 544 are disposed along directions crossing each other.

In addition, in this embodiment, a separator (not shown in the drawing) may be adhered on the lower surface of the lower electrode substrate 54 via an adhesive layer 7.

When the touch panel 50 of this embodiment is mounted on a front surface of the display device 9 such as a color liquid crystal display, the separator (not shown in the drawing) of the touch panel 50 of this embodiment is removed first to expose the adhesive layer 7, and it is contacted with the front surface of the display device 9 so that they face each other. A color liquid crystal display having a touch panel can be thereby formed.

In such a liquid crystal display device having a touch panel, when the upper surface of the upper electrode substrate 52 is pushed down by a user with a finger, pen or the like with recognizing images displayed on the display device 9 disposed on the back surface of the touch panel 50, the upper electrode substrate 52 is deflected, and the upper transparent conductive film 524 of the pushed part is brought into contact with the lower transparent conductive film 544. By electrically detecting this contact via the pair of upper and lower electrodes, the pushed position is detected.

In this embodiment, the upper transparent substrate 522 of the upper electrode substrate 52 as a movable electrode includes the anti-Newton ring sheet 1 of this embodiment (FIGS. 1 and 2), and the upper transparent conductive film 524 is designed so as to be formed on the surface of the anti-Newton ring sheet 1 on the side on which the uneven pattern that can include or can consist of the structural rows 2 is formed.

In addition, the upper transparent substrate 522 can also be constituted with the anti-Newton ring sheet 1b or 1c having a different configuration (for example, FIGS. 3 and 4). In such a case, the upper transparent conductive film 524 may be similarly designed so as to contact with the surface of the anti-Newton ring sheet 1b or 1c on the side on which the uneven pattern that can include or can consist of the structural rows 2 is formed.

Further, the uneven pattern can also be formed by, for example, inversely forming such a similar uneven pattern 1a that can include or can consist of structural rows 2 as shown in FIG. 6 on the separator (not shown in the drawing), and transferring this on the upper transparent conductive film 524.

In this embodiment, the lower transparent substrate 542 of the lower electrode substrate 54 as a fixed electrode is constituted with, for example, glass or the like.

In addition, in this embodiment, also in the lower electrode substrate 54, the lower transparent substrate 542 can include the anti-Newton ring sheet 1 of this embodiment, and the lower transparent conductive film 544 can also be designed so as to be formed on the surface of the anti-Newton ring sheet 1 on the side on which the uneven pattern that can include or can consist of the structural rows 2 are formed, as in the upper electrode substrate 52.

As described above, the touch panel 50 using the anti-Newton ring sheet 1 of this embodiment can avoid generate glaring of color screen, even when it is used in recently used various displays of higher definition, and therefore it can be a touch panel not degrading visibility of a display.

When the anti-Newton ring sheet 1 is incorporated into the touch panel 50, the extending directions of the ridgelines of the structural rows 2 of the anti-Newton ring sheet 1 and disposition direction of a regular structure of a liquid crystal panel or the like having the regular structure may not be in parallel, and they may diverge (the both directions cross on their extension lines and an angle at the crossing point of the both directions is in the range of 5 to 95°). If such a structure is used, moiré that may be generated depending on the combination of the anti-Newton ring sheet 1 and a liquid crystal panel or the like having a regular structure can be favorably prevented.

### EXAMPLES

### 1. Production of Anti-Newton Ring Sheets

### Example 1

A copper plate having a thickness of 4 mm and a smooth surface was cut with a diamond cutting tool for sculpture to produce a metal mold. To the produced metal mold, a mixture of 50 weight parts of acrylic monomers (methyl methacrylate, Wako Pure Chemical Industries, Ltd.), 45 parts of polyfunctional acrylic monomers (NK Ester A-TMPT-3EO, Shin-Nakamura Chemical Co., Ltd.) and 5 parts of a photopolymerization initiator (Irgacure 184, Ciba Japan K.K.) as an ultraviolet curable resin was dropped, the mold was covered with a polyester film having a thickness of 100 μm (COSMOSHINE A4300, Toyobo Co., Ltd.), and the resin was uniformly spread with a roller so that bubbles should not remain to closely contact the resin and the polyester film.

The resin and the film in this state were irradiated with ultraviolet radiation of 1500 mJ/cm² using a metal halide lamp from the polyester film side to cure the ultraviolet curable resin, and then the polyester film and the resin were delaminated from the metal mold to faithfully transfer the profile of the metal mold and thereby produce an anti-Newton ring sheet of Example 1 (one having the structure of FIG. 5). The characteristics of the structure of the structural rows of the anti-Newton ring sheet of Example 1 are shown in Table 1.

### Examples 2 to 10

Anti-Newton ring sheets of Examples 2 to 10 were produced in the same manner as that of Example 1 except that the copper plate was cut according to cutting conditions different from those of Example 1. The characteristics of the structure of the structural rows of the anti-Newton ring sheets of Example 2 to 10 are shown in Table 1.

### Comparative Example 1

On one surface of a polyester film as a support, the same as that used in Example 1, a coating solution for anti-Newton ring layer having the following composition was applied, dried, and irradiated with ultraviolet radiation using a high pressure mercury lamp to form an anti-Newton ring layer having a thickness of 2 μm and thereby produce an anti-Newton ring sheet of Comparative Example 1.

<Composition of coating solution for anti-Newton ring layer of Comparative Example 1>

| | | |
|---|---|---|
| Ionizing radiation curable resin | 50 | parts |
| (solid content: 100%, Beamset 575, | | |
| Arakawa Chemical Industries Ltd.) | | |
| Microparticles (acrylic resin particles, | 0.4 | part |
| mean particle size: 3 μm) | | |
| Photopolymerization initiator | 1.5 | parts |
| (Irgacure 651, Ciba Japan K.K.) | | |
| Isopropyl alcohol | 200 | parts |

### Comparative Example 2

An anti-Newton ring sheet of Comparative Example 2 was produced in the same manner as that of Example 1 except that the copper plate was cut according to cutting conditions different from those of Example 1. The structural characteristics of the structure of the structural rows of the anti-Newton ring sheet of Comparative Example 2 are shown in Table 1.

TABLE 1

| | Structure of structural row | | | | | |
|---|---|---|---|---|---|---|
| | | Var- | Period of | Average | | |
| | Sec- | iation | height | height | | |
| | tional | of | variation | (variation) | Width | Pitch |
| | shape | height | (μm) | (μm) | (μm) | (μm) |
| Example 1 | Square | Regular | 400 | 5 (3) | 10 | 400 |
| Example 2 | Square | Regular | 25 | 6 (4) | 10 | 500 |
| Example 3 | Square | Regular | 15 | 4 (2) | 5 | 100 |
| Example 4 | Square | Regular | 4500 | 3 (1) | 5 | 150 |
| Example 5 | Semi- | Regular | 3800 | 5 (3) | 3 | 200 |
| | circle | | | | | |
| Example 6 | Semi- | Regular | 2500 | 0.5 (0.3) | 3 | 300 |
| | circle | | | | | |
| Example 7 | Triangle | Regular | 1800 | 3 (1) | 35 | 800 |
| Example 8 | Triangle | Random | — | 4 (2) | 20 | 450 |
| Example 9 | Square | Regular | 150 | 5 (2) | 8 | 400 |
| Example 10 | Square | Regular | 500 | 6 (5) | 10 | 450 |
| Comparative | — | — | — | 2 (2) | — | — |
| Example 1 | | | | | | |
| Comparative | Triangle | None | — | 10 (0) | 150 | None |
| Example 2 | | | | | | |

### 2. Production of Touch Panels

### (1) Production of Panel Plate of Upper Electrode

On the anti-Newton ring layer of each of the anti-Newton ring sheets of Examples 1 to 10 and Comparative Examples 1 and 2 mentioned above, an ITO conductive film having a thickness of about 20 nm was formed by sputtering, and a hard coat film (KB film N05S, Kimoto Co., Ltd.) was adhered to the other surface via an adhesive layer, and then they were cut into a 4-inch size (rectangle having a length of 87.3 mm and a width of 64.0 mm) to produce each panel plate of the upper electrode.

### (2) Production of Panel Plate of Lower Electrode

An ITO conductive film having a thickness of about 20 nm was formed by sputtering on one surface of a tempered glass plate having a thickness of 1 mm as a support, and then they were cut it into a 4-inch size (rectangle having a length of 87.3 mm and a width of 64.0 mm) to produce a panel plate of the lower electrode.

### (3) Production of Spacers

On the surface having the conductive film of the aforementioned panel plate of the lower electrode, dots were printed with an ionizing radiation curable resin (Dot Cure TR5903, Taiyo Ink Mfg. Co., Ltd.) as a coating solution for spacer by screen printing, and ultraviolet irradiation was performed with a high pressure mercury lamp to dispose spacers having a diameter of 50 μm and a height of 8 μm with intervals of 1 mm.

### (4) Production of Touch Panels

The aforementioned panel plate of the upper electrode and the panel plate of the lower electrode were disposed so that the conductive films of the panel plates should face each other, and edges defined so as to be out of the display region were adhered with a double-sided adhesive tape having a thickness of 30 μm and a width of 3 mm to produce touch panels of Examples 1 to 10 and Comparative Examples 1 and 2.

### 3. Evaluation

### (1) Anti-Newton Ring Property of Anti-Newton Ring Sheets

The surface on which the structural rows were formed of each of the anti-Newton ring sheets obtained in Examples 1 to 10 and Comparative Examples 1 and 2 was placed on a glass plate having a smooth surface, closely contacted with it, and pressed against the glass plate by pushing the sheet with a finger, and whether Newton rings were generated or not was evaluated by visual inspection. Evaluation results are indicated with the symbol “⊚” when Newton rings were not generated at all, with the symbol “◯” when a quite few Newton rings were generated, but they did not affect the visibility at all, with the symbol “Δ” when a few Newton rings were generated, but they did not degrade the visibility, and with the symbol “X” when Newton rings were generated, and they degraded the visibility. The evaluation results are shown in Table 2.

### (2) Anti-Glaring Property of Touch Panels

The lower electrode side of each of the touch panels of Examples 1 to 10 and Comparative Examples 1 and 2 was closely contacted with a display screen of a CRT display monitor displaying a 100% green image, and glaring was evaluated by visual inspection. Evaluation results are indicated with the symbol “⊚” when no glaring was observed, with the symbol “◯” when glaring was scarcely observed, with the symbol “Δ” when glaring was slightly observed, with the symbol “X” when glaring was distinctly observed, and with the symbol “XX” when marked glaring was observed. The evaluation results are shown in Table 2.

TABLE 2

| | Anti-Newton ring | Anti-glaring |
|---|---|---|
| | property | property |
| Example 1 | ⊚ | ⊚ |
| Example 2 | ⊚ | ⊚ |
| Example 3 | ⊚ | Δ |
| Example 4 | Δ | ⊚ |
| Example 5 | ⊚ | ⊚ |
| Example 6 | ◯ | ⊚ |
| Example 7 | ⊚ | ◯ |
| Example 8 | ⊚ | Δ |
| Example 9 | ⊚ | ⊚ |
| Example 10 | ⊚ | ⊚ |
| Comparative | ◯ | X X |
| Example 1 | | |
| Comparative | ◯ | X |
| Example 2 | | |

As clearly seen from the results shown in Table 2, in the anti-Newton ring sheets of Examples 1 to 10, a plurality of structural rows were disposed side by side with a pitch, the heights of the structural rows varied along the extending directions of the ridgelines thereof, therefore they showed superior anti-Newton ring property, and the touch panels of Examples 1 to 10 using these could be touch panels not generating sparkles and glaring of color screen, and not degrading visibility of the display, when they were used in the CRT color display.

In particular, in the anti-Newton ring sheets of Examples 1 to 7, 9 and 10, the heights of the structural rows periodically varied, and therefore the touch panels using them generally showed superior balance of the anti-Newton ring property and the anti-glaring property. Further, in the anti-Newton ring sheet of Example 8, the heights of the structural rows randomly varied, and therefore the touch panel of Example 8 using this anti-Newton ring sheet could show the anti-Newton ring property and the anti-glaring property, and in addition, it could favorably prevent moiré that may be generated when combined with a liquid crystal panel having a regular structure.

Among these, especially in the anti-Newton ring sheets of Examples 1, 2, 5 to 7, 9 and 10, the periods of the variation of the heights of the structural rows were within the range of 20 to 4000 μm, and therefore the touch panels utilizing them showed further superior balance of the anti-Newton ring property and the anti-glaring property. In particular, in the anti-Newton ring sheets of Examples 9 and 10, the variation of the heights of the structural rows were within the range of 150 to 500 μm, and therefore the touch panels utilizing them showed markedly superior balance of the anti-Newton ring property and the anti-glaring property.

On the other hand, in the anti-Newton ring sheet of Comparative Example 1, the anti-Newton ring layer contained microparticles besides the polymer resin, and the unevenness on the surface of the anti-Newton ring layer was formed by the microparticles. Therefore, although this anti-Newton ring sheet showed the anti-Newton ring property, when it was used as a touch panel member, the microparticles existing in the anti-Newton ring layer served as bright spots to generate sparkles, and thus the touch panel showed extremely poor anti-glaring property. Further, the haze value thereof rose due to difference of the refractive indexes of the polymer resin and the microparticles, and due to non-uniform uneven profile of the anti-Newton ring sheet surface, and thus it showed poor transparency.

In the anti-Newton ring sheet of Comparative Example 2, a convex pattern was formed by shape transfer technique without using microparticles as in the Examples 1 to 10, but the heights of the structures did not vary along the extending directions of the ridgelines thereof, and therefore it did not show superior anti-Newton ring property comparable to that of the anti-Newton ring sheets of Examples 1 to 10. Further, since the surface profile of the anti-Newton ring layer of the anti-Newton ring sheet of Comparative Example 2 was consisted of a plurality of conventionally contemplated structural rows disposed side by side, and therefore it generated sparkles, and gave distinct glaring of the color screen, when it was used for a CRT color display of higher definition used in recent years, and thus showed poor anti-glaring property.

1. An anti-Newton ring sheet having an uneven pattern on a surface thereof, the uneven pattern comprising:
a plurality of structural rows of which heights vary along extending directions of ridgelines thereof, and the structural rows are disposed side by side with a pitch in a direction crossing the extending directions of the ridgelines.

2. The anti-Newton ring sheet according to claim 1, wherein the heights of the structural rows periodically vary along the extending directions of the ridgelines.

3. The anti-Newton ring sheet according to claim 2, wherein period of variation of the heights of the structural rows is 20 to 4000 μm.

4. The anti-Newton ring sheet according to claim 1, wherein the structural rows include a polymer resin.

5. The anti-Newton ring sheet according to claim 1, wherein average height of the structural rows is 0.8 μm or larger.

6. The anti-Newton ring sheet according to claim 1, wherein the structural rows have a width of 2 to 30 μm at a base part of a structural row.

7. The anti-Newton ring sheet according to claim 1, wherein:
a hard coat layer is provided on the surface of the side opposite to the side on which the uneven pattern is formed.

8. A resistance film type touch panel including the anti-Newton ring according to claim 1 comprising:
a pair of panel plates each having a conductive film and disposed via a spacer so that the conductive films face each other, wherein:
one or both of the conductive films are formed on the surface of the anti-Newton ring sheet on which the uneven pattern is formed.

9. The anti-Newton ring sheet according to claim 2, wherein the structural rows include a polymer resin.

10. The anti-Newton ring sheet according to claim 2, wherein average height of the structural rows is 0.8 μm or larger.

11. The anti-Newton ring sheet according to claim 2, wherein the structural rows have a width of 2 to 30 μm at a base part of a structural row.

12. The anti-Newton ring sheet according to claim 2, wherein:
a hard coat layer is provided on the surface of the side opposite to the side on which the uneven pattern is formed.

13. A resistance film type touch panel including the anti-Newton ring according to claim 1 comprising:
a pair of panel plates each having a conductive film and disposed via a spacer so that the conductive films face each other, wherein:
one or both of the conductive films are formed on the surface of the anti-Newton ring sheet on which the uneven pattern is formed.

14. The anti-Newton ring sheet according to claim 3, wherein the structural rows include a polymer resin.

15. The anti-Newton ring sheet according to claim 3, wherein average height of the structural rows is 0.8 μm or larger.

16. The anti-Newton ring sheet according to claim 3, wherein the structural rows have a width of 2 to 30 μm at a base part of a structural row.

17. The anti-Newton ring sheet according to claim 3, wherein:
a hard coat layer is provided on the surface of the side opposite to the side on which the uneven pattern is formed.

18. The anti-Newton ring sheet according to claim 4, wherein average height of the structural rows is 0.8 μm or larger.

19. The anti-Newton ring sheet according to claim 5, wherein the structural rows have a width of 2 to 30 μm at a base part of a structural row.

20. The anti-Newton ring sheet according to claim 6, wherein:
a hard coat layer is provided on the surface of the side opposite to the side on which the uneven pattern is formed.
